(19) United States
(12) Patent Application Publication
(10) Pub. No.: US 2026/0349749 A1
(43) Pub. Date: Nov. 5, 2026

(54) COLLABORATION AND MANAGEMENT OF CONTROLLERS FOR CONTAINER OPERATORS

(71) Applicant: International Business Machines Corporation, Armonk, NY (US)

(72) Inventors: Zhi Li Guan, Beijing (CN); Hai Wei F Fang, Beijing (CN); Guo Liang Huang, Beijing (CN); Shi Su, Beijing (CN); Fang Tai L Li, Beijing (CN); Yun Diao, Beijing (CN)

(21) Appl. No.: 19/739,356

(22) Filed: Jul. 13, 2026

Related U.S. Application Data
(63) Continuation of application No. 18/384,451, filed on Oct. 27, 2023.

(51) Int. Cl. G06F 9/445

(52) U.S. Cl. CPC G06F 9/44505

(57) ABSTRACT

Mechanisms are provided, in a data processing system that implements a computer container management platform in which Operators and Operator Controllers are used to manage at least one custom resource associated with a containerized application, to receive an Operator Deployment comprising an Operator Container having an Operator with a plurality of Operator Controllers. A process control manager (PCM) process configures each Operator Controller to execute as a separate process from each of the other Operator Controllers of the Operator Container. The Operator of the Operator Container is run at least by executing the Operator Controllers of the Operator in separate Operator runtimes based on the configuring of the Operator Controllers.

### CROSS REFERENCE TO RELATED APPLICATIONS

This application is a Continuation Application of U.S. Patent Application No. 18/384,451 filed on Oct. 27, 2023. The above-referenced application is hereby incorporated herein by reference in its entirety.

### BACKGROUND

The present application relates generally to an improved data processing apparatus and method and more specifically to an improved computing tool and improved computing tool operations/functionality for collaboration and management of Controllers for container Operators.

Containers are a way to bundle and run applications by specifically placing both the application code and its dependencies into a lightweight, standalone, executable environment. Because everything that is needed for running the application is packaged together into the container, applications can run more quickly and reliability regardless of the computing environment in which they are deployed. Containers have their own filesystem and their own share of processor, memory, process space, and other resources. Because they are not coupled to the underlying infrastructure, they are portable to various execution environments. Containers are generated from container images, which may be defined by the user, or which may be reused from container image repositories. Examples of container technology include the Docker® container mechanisms available from Docker, Inc. and Kubernetes® (also referred to as K8s) available from the Linux Foundation. In Kubernetes®, one or more containers are provided in a basic scheduling unit referred to as a Pod.

The containers that run the applications need to be managed in the production environment in order to ensure no downtime. Kubernetes® provides a portable, extensible open source platform for managing containerized workloads and services. For example, if a container goes down, another container needs to start. Kubernetes® provides a framework to run distributed systems resiliently by providing a system that handles scaling and failover of applications, provides deployment patterns, etc.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system specifically configured to implement a computer container management platform in which Operators and Operator Controllers are used to manage at least one custom resource associated with a containerized application, the method comprising receiving an Operator Deployment comprising an Operator Container having an Operator with a plurality of Operator Controllers. In addition, the method comprises configuring, by a process control manager (PCM) process, each Operator Controller to execute as a separate process from each of the other Operator Controllers of the Operator Container. Moreover, the method comprises running the Operator of the Operator Container at least by executing the Operator Controllers of the Operator in separate Operator runtimes based on the configuring of the Operator Controllers.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example of a container management platform;

FIG. 2 is an example diagram of a distributed data processing system environment in which aspects of the illustrative embodiments may be implemented and at least some of the computer code involved in performing the inventive methods may be executed;

FIG. 3 is an example block diagram illustrating primary operational components of a Kubernetes container management platform with improved Operator Deployment in accordance with one illustrative embodiment;

FIG. 4 is an example diagram illustrating an update to Operator logic in accordance with one illustrative embodiments;

FIG. 5 is an example diagram illustrating a Process Control Manager (PCM) configuration in accordance with one illustrative embodiment;

FIG. 6 is an example diagram of a status user interface in accordance with one illustrative embodiment;

FIG. 7 is an example diagram of status user interface probes in accordance with one illustrative embodiment;

FIG. 8 is an example diagram illustrating an operational flow for graceful exiting in response to a NotReady status in accordance with one illustrative embodiment; and

FIG. 9 is an example diagram of code for specifying an Operator container with graceful exit functionality in accordance with one illustrative embodiment.

### DETAILED DESCRIPTION

The illustrative embodiments provide an improved computing tool and improved computing tool operations/functionality for collaboration and management of Controllers for Operators. The illustrative embodiments will be described herein with reference to a Kubernetes® container management platform and thus, will make reference to components of that specific container management platform using the terminology specific to Kubernetes®. However, it should be appreciated that the mechanisms of the illustrative embodiments may also be adapted to other container management platforms that utilize similar components and platforms, regardless of the particular terminology used.

Assuming a Kubernetes® container management platform embodiment for illustrative purposes, the improved computing tool and improved computing tool operations/functionality introduces a system level process manager to manage Operator Controllers and provide a graceful shutdown mechanism that improves the operation of the platform. To better understand the advantages provided by the improved computing tool and improved computing tool operations/functionality, it is best to first have a general understanding of the primary components of the Kubernetes® container management platform and its components. It should be appreciated that the following is not intended to be a primer on the Kubernetes® container management platform, but only highlights some aspects of the Kubernetes® container management platform for purposes of context when describing the improvements provided by the present invention. It is assumed for purposes of this description that one of ordinary skill in the art has a knowledge of Kubernetes®.

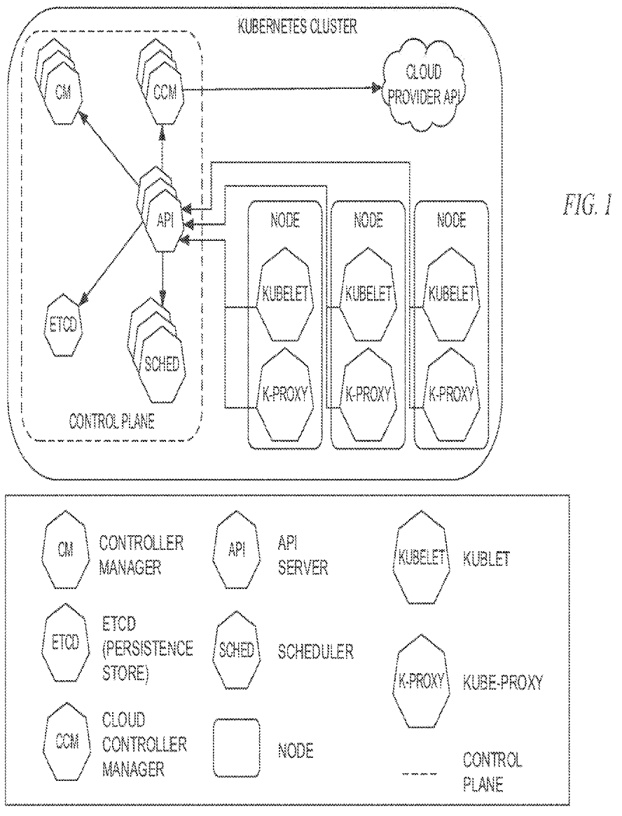

FIG. 1 is provided as an example of the Kubernetes® container management platform and its components. As shown in FIG. 1, the container management platform 100, when Kubernetes® is deployed to a computing infrastructure, one obtains a Kubernetes® cluster. The cluster comprises a set of worker machines, called nodes, that run containerized applications. Every cluster has at least one worker node, with each worker node hosting the Pods. The Pods are the components of the application workload, with each Pod having one or more containers. The control plane manages the worker nodes and the Pods in the cluster. In production environments, the control plane may run across multiple computers and a cluster may run multiple nodes, providing fault-tolerance and high availability.

The control plane components make global decisions about the cluster, e.g., scheduling decisions, as well as detect and respond to cluster events, e.g., starting up a new Pod when a Deployment’s replicas field is unsatisfied. Control plane components can be run on any machine in the cluster. However, for simplicity, setup scripts may start control plane components on the same machine, and do not run user containers on this machine.

The API server is a front end component of the control plane that exposes the Kubernetes API. The Kubernetes API is a REST API that allows for communication between end users, different parts of the cluster, and external components. The Kubernetes API provides functionality to query and manipulate the state of API objects in Kubernetes, e.g., Pods, namespaces, configuration maps, events, etc. The main implementation of the API server is kube-apiserver which is designed to scale horizontally. That is, kube-apiserver scales by deploying more instances. Several instances of kube-apiserver may be run and traffic balanced between those instances. Etcd provides a consistent and highly-available key value store used as a backing store for all cluster data.

Kube-scheduler is a control plane component that watches for newly created Pods with no assigned node, and selects a node for them to run on. Factors taken into account for scheduling decisions include individual and collective resource requirements, hardware/software/policy constraints, affinity and anti-affinity specifications, data locality, inter-workload interference, and deadlines.

The kube-Controller-manager is a control plane component that runs Controller processes. The Controller processes are control loops that watch the state of a cluster and makes or requests changes to the state where needed. Each Controller tries to move the current cluster state closer to a desired state. To understand Controllers, consider a non-terminating loop that regulates the state of a system, such as a thermostat in a room, as an example. When the temperature is set on the thermostat, the setting tells the thermostat the desired state. The actual measured temperature in the room is the current state, and the thermostat’s operation is intended to control the heating/air conditioning to bring the current state closer to the desired state. The Controllers in Kubernetes track the state of at least one Kubernetes resource object. These objects have a specific field that designate the desired state. The Controllers may carry out actions themselves to bring the current state closer to the desired state, or may communicate with other components through the Kubernetes API and API server to have the other components perform actions to adjust the state.

As an example, a Job Controller is an example of a Kubernetes built-in Controller (a Controller that manages state by interacting with the cluster API server). The “Job” is a Kubernetes resource that runs one or more Pods in order to perform a task. When the Job Controller sees a new task it makes sure that, somewhere in the cluster, the kubelets (node agent running on a node) on a set of Nodes are running the right number of Pods to get the work done. The Job Controller does not run any Pods or containers itself but, instead, tells the API server to create or remove Pods. Other components in the control plane act on the new information, such as by scheduling and running additional Pods, until the task is completed. After a new Job resource is created, the desired state is for that Job resource is for it to be completed. The Job Controller makes the current state for that Job be nearer to the desired state (completed) by controlling the creation of Pods that perform the work for that Job. Controllers also update the objects that configure them. For example: once the work is done for a Job, the Job Controller updates that Job object (resource) to mark it as “finished.”

In contrast with the Job Controller, some Controllers need to make changes to things outside of the cluster. For example, if one uses a control loop to make sure there are enough nodes in the cluster, then that Controller needs something outside the current cluster to set up new nodes when needed. Controllers that interact with external state find their desired state from the API server, and then communicate directly with an external system to bring the current state closer to the desired state.

Thus, the Controllers operate to make changes to bring about a desired state, and then reports the current state back to the cluster's API server. Other Controllers can observe that reported data and take their own actions accordingly. Kubernetes® takes a cloud-native view of systems, and is able to handle constant change, since clusters may change state at any point as work is performed. Controllers, or control loops, automatically monitor and adjust to state changes and operate to address failures.

Kubernetes® uses a plethora of Controllers that each manage a particular aspect of cluster state. Most commonly, a particular Controller will use one type of resource as its desired state, and has a different type of resource that it manages to make that desired state happen. For example, a Controller for Jobs tracks Job objects (resources) and Pod objects (to run the Jobs, and then to see when the work is finished). In this case something else creates the Jobs, whereas the Job Controller creates Pods. There can be more than one Controller that creates or updates the same type of object, the Controllers operating only with regard to the resources linked to their controlling resource. For example, one can have Deployments and Jobs which both create Pods, but the Job Controller does not delete Pods that the deployment created because there is information (labels) the Controllers use to tell those Pods apart from one another. A Kubernetes® Deployment is a resource object that provides declarative updates to applications and describes an applications’ life cycle, such as which images to use for the application, the number of Pods there should be, and the way in which those Pods should be updated.

Kubernetes comes with a set of built-in Controllers that run inside the kube-Controller-manager. These built-in Controllers provide important core behaviors. The deployment Controller and Job Controller are examples of Controllers that come as part of Kubernetes itself, and thus are referred to as “built-in” Controllers. Additional Controllers may be obtained that run outside the control plane to extend the Kubernetes platform. In addition, users can create their own Controllers which may be run as a set of Pods.

To reduce complexity, Controllers are compiled into a single binary and run in a single process. There are many different types of Controllers including a node Controller, Job Controller, EndpointSlice Controller, ServiceAccount Controller, route Controller, service Controller, and the like. The node Controller is responsible for noticing and responding when nodes go down. The Job Controller watches for Job objects that represent one-off tasks, then creates Pods to run those tasks to completion. The EndpointSlice Controller populates EndpointSlice objects (to provide a link between Services and Pods). The ServiceAccount Controller creates default ServiceAccounts for new namespaces. The route Controller operates to set up routes in the underlying cloud infrastructure. The service Controller operates to create, update, and delete cloud provider load balancers. The node Controller, route Controller, and service Controller may all have cloud provider dependencies. These are only examples of Controllers and is not exhaustive of the Controllers that may be employed in the control plane of the container management platform 100.

The cloud Controller manager is a control plane component that embeds cloud-specific control logic that operates to link a cluster into a cloud provider's API, and separates out the components that interact with that cloud platform from components that only interact with the cluster. The cloud-Controller-manager only runs Controllers that are specific to the cloud provider. If the cluster is being executed in a non-cloud infrastructure, the cluster does not have a cloud Controller manager. As with the kube-Controller-manager, the cloud-Controller-manager combines several logically independent control loops into a single binary that can be run as a single process.

Node components run on every node, maintaining running Pods and providing the Kubernetes runtime environment. In the node, a kubelet is executed that operates as an agent process that makes sure that containers are running in a Pod. The kubelet takes a set of PodSpecs that are provided through various mechanisms and ensures that the containers described in those PodSpecs are running and healthy.

Kube-proxy is a node component that operates as a network proxy running on each node in the cluster and implements part of the Kubernetes Service. The kube-proxy maintains network rules on nodes which allow network communication to the Pods from network sessions inside or outside of the cluster. Kube-proxy uses the operating system packet filtering layer if there is one available, otherwise it forwards the traffic itself.

The container runtime is a fundamental component of the node that is responsible for managing the execution and lifecycle of containers within the Kubernetes environment. Kubernetes supports container runtimes such as containerd, container runtime interface (CRI)-O, and any other implementations of the Kubernetes CRI.

A Kubernetes Operator, or simply “Operator” as used herein, is a custom Kubernetes Controller that uses custom resources (CR) to manage applications and their components. The Operators are tailored to specific applications, follow the control loop principles of Controllers, and extend a clusters behavior by linking Operator Controllers to one or more CRs without modifying the code of Kubernetes itself. The Operator Controllers are designed to transition the cluster into the desired state of the application. Operators operate to automate processes, such as processes directed to repeated behaviors. Examples of processes that may be automated by Operators include, but are not limited to: deploying an application on demand, taking and restoring backups of the application state, handling upgrades of the application code alongside related changes such as database schemas or extra configuration settings, publishing a Service to applications that do not support Kubernetes APIs to discover them, simulating failure in all or part of the cluster to test cluster resilience, choosing a leader for a distributed application without an internal member election process.

As an example, an Operator may have a custom resource named CustomDB, that can be configured into the cluster, a Deployment that makes sure a Pod is running that contains the Operator Controller part of the Operator, a container image of the Operator code, and Operator Controller code that queries the control plane to find out what CustomDB resources are configured.

The core of the Operator is code to tell the API server how to make reality match the configured resources. For example, if a new CustomDB is added, the Operator sets up PersistentVolumeClaims to provide durable database storage, a StatefulSet to run CustomDB and a Job object to handle initial configuration. If the CustomDB is deleted, the Operator takes a snapshot and then makes sure that the StatefulSet and Volumes are also removed. The Operator also manages regular database backups. For each CustomDB resource, the Operator determines when to create a Pod that can connect to the database and make backups. These Pods rely on a configuration mapping (ConfigMap) and/or a Secret (an object that contains a small amount of sensitive data) that has database connection details and credentials.

Because the Operator aims to provide robust automation for the custom resource(s) it manages, there may be additional supporting code. For example, using the CustomDB example above, supporting code may be provided that checks to see if the database is running an old version and, if so, creates Job objects that upgrade it to the current version.

The most common way to deploy an Operator is to add the Custom Resource Definition (CRD) and its associated Operator Controller to a cluster. The Operator Controller will normally run outside of the control plane. For example, the Operator Controller can be run in a cluster as a Deployment. Once the Operator is deployed, it can be used by adding, modifying or deleting the type of resource that the Operator uses.

Each Operator may manage multiple Controllers, also referred to herein as Operator Controllers. As such, the atomicity of another Operator Controller may be broken if one of the Operator Controllers breaks the Operator process, since all of the Operator Controllers are part of the same Operator process. As a result, the deployed Custom Resource may be in an unrecognized state. For example, consider an Operator Controller that creates two configmaps at the end, one which includes the Custom Resource version, and the other includes the Custom Resource deployment result. The Operator Controller assumes that the two configmaps are created together and both should exist. Each time the Operator Controller begins, it reads the Custom Resource version and deploy result from the two configmaps. However, if the Operator is broken right after one configmap is created, then only one configmap exists. The Operator Controller, as a result, will fail.

The Operator may fail to reconcile even if the Operator Pod is recovered because the atomicity of the Operator process is broken. Moreover, it is difficult to determine the root cause of the failure. That is, using the example above, one can see that the Controller has failed and at which step the failure occurred. However, it cannot be known why there is only one configmap and why the other configmap was not created. The configmap should have been created but the Operator crash, or breaking of the Operator, terminated the creation.

As mentioned above, the illustrative embodiments provide a system level process manager to manage the Operator Controllers and provide a graceful shutdown mechanism. Each Operator Controller can run independently without interfering with the other Operator Controllers of the Operator. In addition, a new status approach is provided to show the overall status of all the Operator Controllers of the Operator. As a result, end users can more easily determine the Operator’s overall status.

In accordance with one or more of the illustrative embodiments, a system level Process Control Manager (PCM) is provided in the Operator Deployment that enables a PCM process in the Operator container. The PCM process is an entry point of the Operator Deployment. The PCM process configures each Operator Controller as an independent process with appropriate settings. The PCM process starts all the Operator Controllers. In addition, the illustrative embodiments reform the existing Operator Controllers to make sure each Operator Controller process can run in parallel against different Custom Resource Definitions (CRDs). For example, each Operator Controller may be controlled to run on a different port to avoid port conflict. Moreover, the Operator logic may be updated to access a parameter that indicates which CRD each Controller should monitor. The CRD name may be passed when the Operator process is started and used to monitor and run the corresponding Operator Controller.

The illustrative embodiments provide a new approach for Operator status that aligns with The PCM configuration and reflects an overall status of multiple Operator Controller processes. That is, the Operator Deployment health check method is updated to introduce a new script to provide Operator Controller process status. With this new script, a user interface status indicator that the Operator is “Ready” indicates that all the Operator Controller processes are running as expected. A user interface status indicator that the Operator is “NotReady” indicates that one or more of the Operator Controller processes are not running as expected.

The illustrative embodiments provide a graceful shutdown functionality when the Operator Pod is in a NotReady state. That is, when the failed Operator Controller process reaches a specified limit, the Operator will trigger a restart of the Operator Controller. The Operator Pod life cycle is configured to control and ensure all Operator Controllers execute to an end state before the Operator Controller restart is triggered.

With the mechanisms of the illustrative embodiments, an improved computing tool and improved computing tool operations/functionality are provided to ensure that management of automated process containers, such as control loop elements, e.g., Controllers managed by Operators in Kubernetes®, are executed with improved health status by reducing occurrences of unrecoverable state scenarios with regard to the control loop elements. The illustrative embodiments provide mechanism for informing the status of Controllers within an Operator. In some embodiments this is a status across all Controllers of the Operator, while in other illustrative embodiments, the status may be with respect to each individual Controller of the Operator.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A "mechanism," as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of’, and “one or more of’ with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an improved container management platform in management components, e.g., Operators in Kubernetes®, of control loop elements, e.g., Controllers in Kubernetes®, are improved to avoid break conditions due to individual control loop elements failing, and for improving the reporting of control loop element status. The improved computing tool implements mechanism and functionality, such as an improved Operator Deployment, which cannot be practically performed by human beings either outside of, or with the assistance of, a technical environment, such as a mental process or the like. The improved computing tool provides a practical application of the methodology at least in that the improved computing tool is able to ensure that management elements for control loop elements, e.g., Operators managing one or more Operator Controllers, run with a health status and that unrecoverable status situations are minimized.

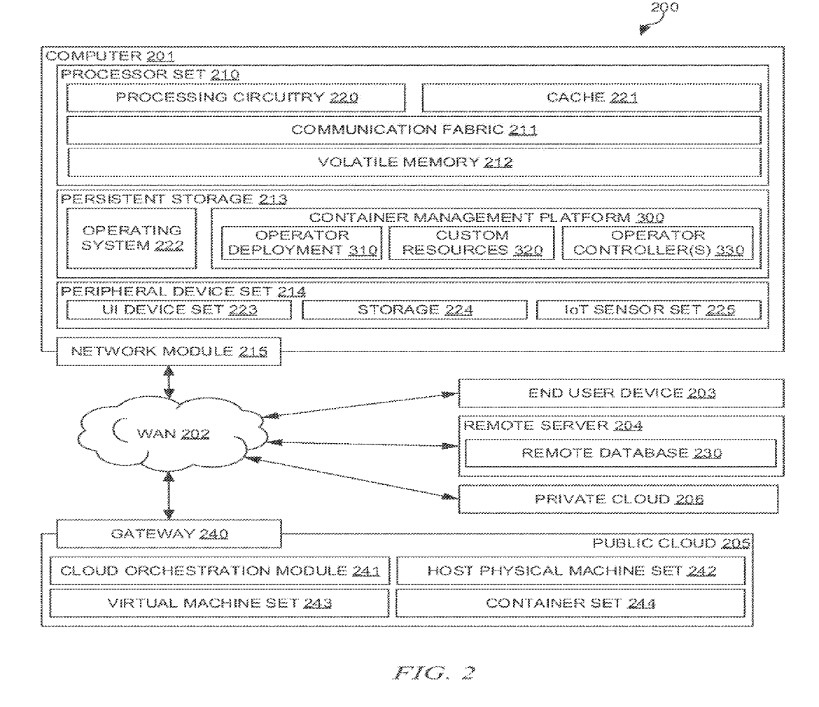

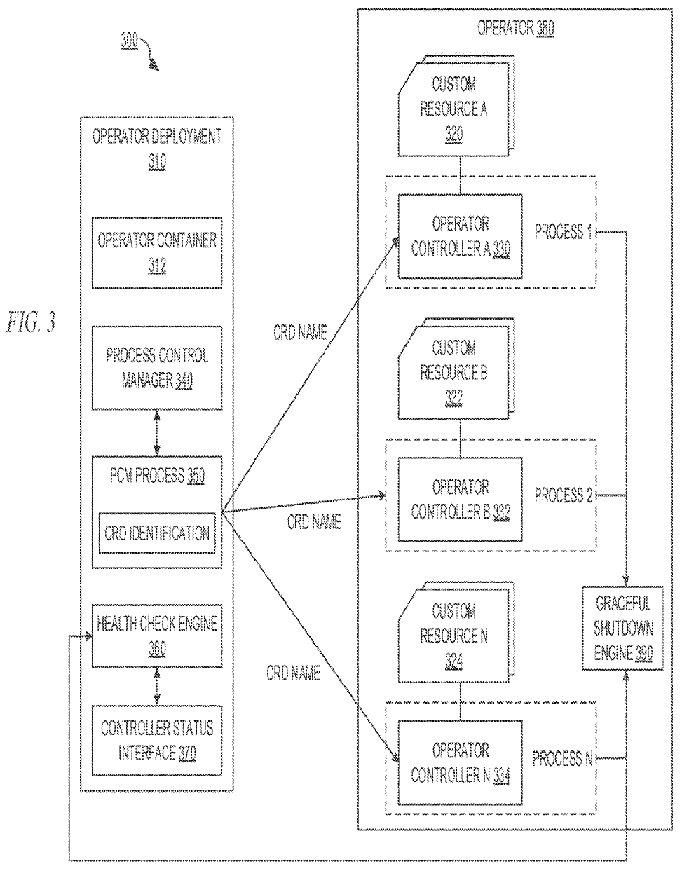

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as code for implementing a Kubernetes container management platform 300 with an Operator Deployment 310, Custom Resources 320, and corresponding Operator Controllers 330. As shown hereafter in FIG. 3, the Operator Deployment 310 comprises a Process Control Manager (PCM) 340, a PCM process 350 that provides custom resource definition identification and controller configuration, a health check engine 360, and a Controller status interface 370. The components will be described in greater detail hereafter in FIG. 3. In addition to block XZ00, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and Kubernetes container management platform 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in Kubernetes container management platform 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in Kubernetes container management platform 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game Controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, fdes and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a container management platform 300 comprising an Operator Deployment 310, Custom Resources 320, and corresponding Operator Controllers 330. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates Controller management by an Operator such that each Controller executes independent of other Controllers of the Operator, and as separate processes. As a result, if one Controller fails, it does not affect the atomicity of the other Controllers. Moreover, mechanisms are provided for reporting the health of each Controller such that a user can determine where problems arise in the Operator execution.

FIG. 3 is an example block diagram illustrating primary operational components of a Kubernetes container management platform with improved Operator Deployment in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings and the resulting output may aid human beings. The invention is specifically directed to the automatically operating computer components directed to improving the way that Controllers in a container management platform are managed and operate, as well as the way in which the health of Controllers are reported, and providing a specific solution that implements a modified Operator Deployment, Process Control Manager, CRD identifier engine, and Controller status interface, which cannot be practically performed by human beings as a mental process and is not directed to organizing any human activity.

As shown in FIG. 3, the container management platform 300, which in this example is a Kubernetes container management platform 300, comprises an Operator Deployment 310, Custom Resources 320-324, and corresponding Operator Controllers 330-334 of an Operator 380 (it should be noted that the terms “Operator Controller” and just “Controller” are intended to refer to the same type of element, i.e., “Operator Controller”, herein). As mentioned above, the Operator Deployment 310 is a resource object that provides declarative updates to Operators and their Operator Controllers. The Operator Deployment 310 is managed by the Kubernetes backend which ensures that updates to the Operator and its Operator Controllers are performed automatically, which also ensuring that a desired number of Pods are running and available at all times. In accordance with the illustrative embodiments, the Operator Deployment 310 is specifically configured to include a Process Control Manager (PCM) 340 that provides a PCM process 350, a health check engine 360, and a Controller status interface 370 specific to the illustrative embodiments.

The Operator Controllers 330-334 are tailored to specific applications, follow the control loop principles of Controllers in general, and extend a clusters behavior by linking to one or more CRs 320-324 without modifying the code of Kubernetes itself. Operators, such as Operator 380 comprising Operator Controllers 330-334, operate to automate processes, such as processes directed to repeated behaviors.

The Operator Deployment 310 comprises the system level Process Control Manager (PCM) 340 which enables a PCM process 345 in the Operator Container 312. The Operator Deployment 310 manages a set of Pods to run an application workload, where a Pod is a group of one or more containers. The PCM process 345 is an entry point of the Operator Deployment 310. The PCM process 345 configures each Operator Controller 330-334 as an independent process, e.g., Process 1 to Process N, with appropriate settings. The PCM process 345 comprises logic that starts all the Operator Controllers 330-334.

The Operator Controllers 330-334 are configured to make sure each Operator Controller 330-334 process can run in parallel against different Custom Resource Definitions (CRDs). For example, each Operator Controller 330-334 may be controlled via specific configuration by the Operator Deployment 310 and PCM process 350 to run on a different port to avoid port conflict. Moreover, the Operator Controllers 330-334 are configured to have logic to access a parameter that indicates which CRD each Operator Controller 330-334 should monitor. The CRD name may be passed by the PCM process 345 when the Operator Controller 330-334 process, e.g., Process 1 to Process N, is started and used to monitor and run the corresponding Operator Controller 330-334.

As mentioned previously, with existing Operators, the Operator Controllers are compiled into a single process. As a result, if any Operator Controller fails, the failure affects the other Operator Controllers of the Operator and thus, may fail even if the Operator Pod is restarted. As shown in FIG. 3, the Operator Controllers 330-334 execute independently in separate processes, e.g., Process 1 to Process N, with their own CRs 320-324. In some illustrative embodiments, the separate processes may be configured in the PCM at least by configuring each of the Operator controller programs with different ports and environment parameters that are used to execute the Operator controllers separately. Thus, if one Operator controller 330 fails, the failure does not impact the ability of the other Operator Controllers 332-334 to executed to completion.

The illustrative embodiments provide a new approach for Operator status that aligns with the PCM configuration and reflects an overall status of multiple Operator Controller 330-334 processes, e.g., Process 1 to Process N. That is, the Operator Deployment 310 comprises a health check engine 360 that executes a health check method that provides Operator Controller 330-334 process status, e.g., a status indication as to whether each process, e.g., Process 1 to N, is executing correctly or has failed. With the health check engine 360 and health check method, a Controller status interface 370 may provide a status indicator that the Operator is “Ready”, which indicates that all the Operator Controller 330-334 processes 1 to N are running as expected. A user interface status indicator in the Controller status interface 370 indicating that the Operator is “NotReady” indicates that one or more of the Operator Controller 330-334 processes 1 to N are not running correctly, i.e., as expected. Moreover, one may drill down into each Operator representation in the Controller status interface 370 to identify the statuses of the Operator Controllers 330-334, and in some illustrative embodiments each individual Operator Controller 330-334, as to whether the Operator Controller 330-334 processes 1 to N are executing correctly, have failed, or have completed successfully. The Operator Controller 330-334 status will impact the Operator status, e.g., if all of the Operator Controller 330-334 exist codes show that they are running, the Operator status will show that it is running, however, if any Controller reaches a retry limit due to the running of the Controller continuing to fail, then the Operator status will show that it is not operating properly.

In addition to the above, the Operator 380 further comprises graceful shutdown engine 390 which comprises logic that provides a graceful shutdown functionality when the Operator 380 Pod is in a “NotReady” state. That is, when the failed Operator Controller 330-334 process, e.g., Process 2, reaches a specified limit, which may be configured in the PCM 340, the graceful shutdown engine 390 of the Operator 380 will trigger a restart of the Operator Controller 332. The Operator 380 Pod life cycle is configured to control and ensure all Operator Controllers 330-334 execute to an end or wait state before the Operator Controller 332 restart is triggered.

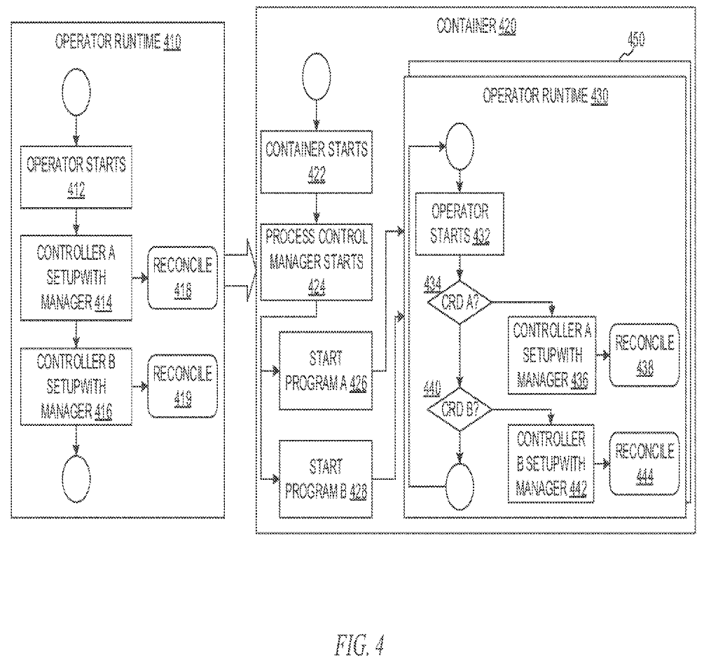

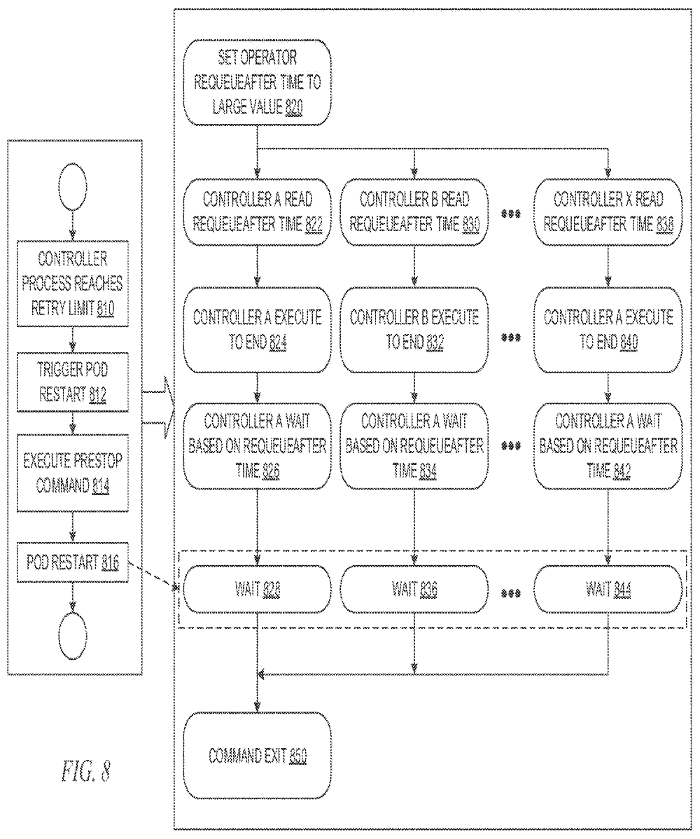

FIG. 4 is an example diagram illustrating an update to Operator logic in accordance with one illustrative embodiments. FIG. 4, as well as FIG. 8, depict flowcharts outlining example operations of elements of the present invention with regard to one or more illustrative embodiments. It should be appreciated that the operations outlined in FIGS. 4 and 8 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 4 or 8, and may, in some cases, make use of the results generated as a consequence of the operations set forth in FIGS. 4 or 8, the operations in FIGS. 4 and 8 themselves are specifically performed by the improved computing tool in an automated manner.

In FIG. 4, on the left hand side of the figure, with regard to elements 412-419, there is depicted an example of an existing Operator runtime 410. As shown on the left hand side of FIG. 4, in the existing Operator runtime 410, the Operator starts (step 412) and the Controller setup managers execute for each of the Controller A (step 414) and Controller B (step 416). The “SetupWithManager” is the entry point that includes all code logic for the corresponding Operator Controllers. Then, in steps 418 and 419, a Kubernetes® Reconcile interface is used to implement a Kubernetes API for a specific resource by creating, updating, or deleting Kubernets objects, or by making changes to systems external to the Kubernetes cluster, e.g., cloud providers. Reconcile implementations compare the state specified in an object by a user against the actual cluster state and then perform operations to make the actual cluster state reflect the sate specified by the user.

Notably, the operator runtime 410 is a single process in which all of the Controllers A and B are setup and executed. Thus, if any one of the Controllers fails, the failure will affect the other Controllers due to the atomicity of the Operator runtime 410 process.

In accordance with the illustrative embodiments, as shown on the righthand side of FIG. 4, the Operator container 420 is updated to comprise logic to execute the Controllers A and B as separate independent and parallel processes (illustrated by the separate boxes 430). As shown in FIG. 4, the Operator container 420 executes logic that starts the container (step 422) and then starts the Process Control Manager (PCM) process (step 424). The PCM process starts the programs A (step 426) and B (step 428), which execute commands to start Operator Controllers A and B respectively, as separate processes. Each process has its own Operator runtime 430 and 450, respectively. In each Operator runtime 430 and 450, the corresponding Operator starts (step 432) and a determination is made as to which Custom Resource Definition (CRD) applies to the Operator runtime 430, 450. A first determination is made as to whether CRD A is to be used (step 432). If so, then Controller A is setup (step 436) and reconciled (step 438). If not, then a second determination is made as to whether CRD B is to be used (step 440). If so, then Controller B is setup (step 442) and reconciled (step 444). If tCRD B is not to be used (step 440), then the process loops for a predetermined number of iterations or time period, e.g., 15 seconds, at which point the process terminates.

Thus, it is important to recognize that the Operator container 420 executes each of the Controllers A and B in their corresponding Operator runtimes 430 and 450 as separate processes. Thus, if Controller A fails it does not impact the execution of Controller B to completion or vice versa. This avoids the problems in the existing Operator runtime 410 where if one Controller fails, e.g., Controller A, the failure may impact the execution of the other Controllers, e.g., Controller B, since they are all part of the same process or Operator runtime 410.

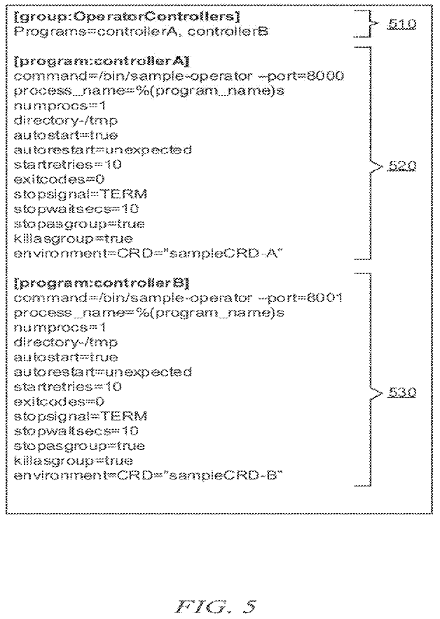

FIG. 5 is an example diagram illustrating a Process Control Manager (PCM) configuration in accordance with one illustrative embodiment. The example shown in FIG. 5 is a sample of a supervisord.cof of a Supervisord Operator Deployment, and is provided only as a non-limiting example. Other types of Operator Deployments may include a Monit, a Linux systemd, or the like. The PCM configuration 500 is specified by the logic of the Operator Deployment, e.g., Operator Deployment 310 in FIG. 3, when configuring the PCM 340 of the Operator Deployment 310. The PCM configuration 500 creates a group 510 for all the Operator Controller programs, e.g., ControllerA and ControllerB in this example. Each of the Operator Controller programs is configured in the PCM with various parameters 520, 530. Each of these programs are run on different ports, e.g., port 8000 and port 8001 in the depicted example. The Operator Controller programs are further configured with different environments for each of the Operator Controller programs, e.g., the environment for ControllerA is “sampleCRD-A” and the environment for ControllerB is “sampleCRD-B”. The configuration shown in FIG. 5 is part of the Operator image and is created by the developer when developing the Operator Controllers.

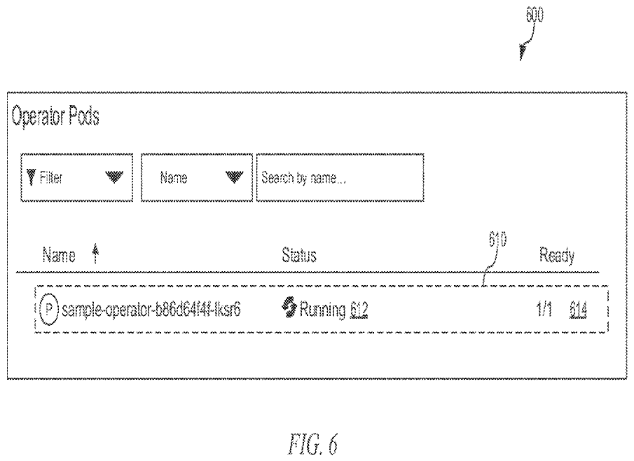

As noted above, the Operator Deployment provides logic for implementing a Controller status interface, e.g., 370 in FIG. 3. FIG. 6 is an example diagram of a Controller status interface in accordance with one illustrative embodiment. As shown in FIG. 6, the Controller status interface 600 comprises entries 610 for each of the Operators with corresponding status indicator 612 and readiness indicator 614. It should be noted that the example shown in FIG. 6 evaluates all the Operator Controllers of the Operator together, while in other illustrative embodiments, each individual Operator Controller status may also be presented for each Operator, or may be drilled down via the interface to access the individual Operator Controller status for the Operator. The values for the status indicator 612 and readiness indicator 614 for an Operator 610 may be determined by a corresponding liveness probe and corresponding readiness probe, where these liveness and readiness probes are Kubernetes® features, e.g., liveness probes are Kubernetes® features for determining when to restart a container and readiness probes are Kubernetes® features used to determine when a container is ready to accept traffic.

With the illustrative embodiments, the liveness probe operates to determine if any of the Controllers of the Operator are running as expected or if none of the Controllers are running and provides a corresponding value, e.g., true or false. For example, the liveness probe may have a value of true if any of the Controllers is running as expected and a value of false if none of the Controllers are running. The readiness probe operates to determine if all of the Controllers are running as expected or if any of the Controllers is not running. The readiness probe may have a value of 1 if all the Controllers are running as expected, and a value of 0 if any of the Controllers is not running.

Thus, by executing the probes, one can determine whether the Controllers of the Operator are ready and running or are not ready or not running. This status for each of the Operators is reflected in the depicted entries 610 of the user interface such that an administrator can determine the operational status of the Operators at a glance.

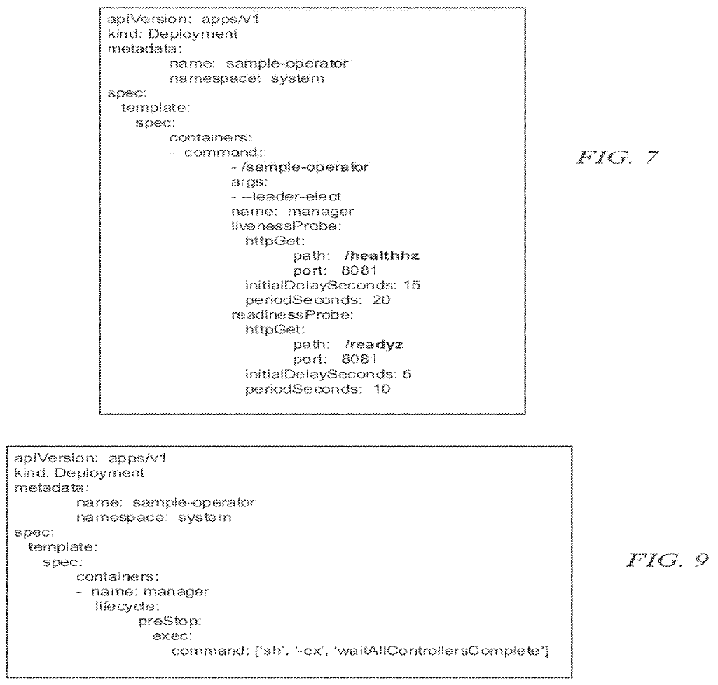

FIG. 7 is an example diagram of status user interface probes in accordance with one illustrative embodiment. As shown in FIG. 7, the API, such as the Kubernetes® API, is configured to implement for each Deployment, a liveness probe and a readiness probe. These probes determine the health of the Deployment by determining the ability of the Controllers of the Operator Deployment to execute properly and start receiving traffic.

FIG. 8 is an example diagram illustrating an operational flow for graceful exiting in response to a “NotReady” status in accordance with one illustrative embodiment. That is, if any one Controller of the Operator is not ready, then a NotReady status is indicated for that Operator and reflected in the readiness status indicator of the user interface. In the case that the Operator is NotReady, then the Operator container exits gracefully by ensuring that all of the Operator Controllers are executed to an end state. The graceful exit logic of the Operator container uses a lifecycle presto configuration to implement this graceful exit as shown in FIG. 8. FIG. 9 is an example diagram of code for specifying an Operator container with graceful exit functionality in accordance with one illustrative embodiment.

As shown in FIG. 8, the operation starts when a Controller process reaches a retry limit, which is set in the Process Control Manager as a configuration parameter (step 810). The container management platform, e.g., Kubernetes® container management platform, triggers a restart of the Controllers (step 812), e.g., performs an Operator Pod restart. In response to the Operator Pod restart being triggered, a Kubernetes® preStop command is executed (step 814). The preStop command causes the operation comprising steps 820-850 to be performed. Once all of the Controllers have executed to an end stated, as shown in the “Wait” operations 828, 836, and 844, allowing for a graceful exit, the Pod restart is performed (step 816).

With regard to the operation comprising steps 820-850, the Operator Requeuing time is set to a large value that allows for the Controllers to reach their end state (step 820). Thereafter each Controller reads the requeue time parameter, e.g., RequeueAfter time (steps 822, 830, and 838) and executes to their respective end state (steps 824, 832, and 840). Each Controller waits a time period based on the Requeue time period (steps 826, 834, 842). While in the Wait state (steps 828, 836, and 844), the Pod restart (step 816) is performed, and the preStop command exits (step 850).

Thus, with this approach, each Controller is supposed to be able to reach an end state. When one Controller cannot recover within a predetermined time, the Operator Pod will be restarted. A new script is provided, e.g., waitAllControllersComplete, as a preStop action. This new script sets the RequeueAfter time to a large value that allows the Controllers to enter an idle status. This means that the Operator Pod restart occurs when all the Controllers are in an idle state which allows for a graceful restart of the Operator Pod.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method implemented in a data processing system specifically configured to implement a computer container management platform in which Operators and Operator Controllers are used to manage at least one custom resource associated with a containerized application, the computer-implemented method comprising:
receiving an Operator Deployment comprising an Operator Container having an Operator with a plurality of Operator Controllers;
configuring, by a process control manager (PCM) process, each Operator Controller to execute as a separate process from each of remaining Operator Controllers of the plurality of Operator Controllers;
running the Operator of the Operator Container at least by executing the plurality of Operator Controllers of the Operator in separate Operator runtimes based on the configuring of the plurality of Operator Controllers;
monitoring execution of each Operator Controller to determine a failure state associated with each Operator Controller;
determining that the failure state of a first Operator Controller satisfies a failure threshold based on the monitoring of the execution; and
initiating a restart of the first Operator Controller and maintaining execution of one or more other Operator Controllers in parallel to the restart of the first Operator Controller, wherein the initiating of the restart is based on the determining that the failure state of the first Operator Controller satisfies the failure threshold.

2. The computer-implemented method of claim 1, wherein the Operator is configured to access a configuration parameter that specifies for each Operator Controller in the plurality of Operator Controllers, a corresponding customer resource definition (CRD) that is associated with the Operator Controller.

3. The computer-implemented method of claim 1, wherein configuring each Operator Controller to execute as the separate process comprises configuring each Operator Controller to execute on a different port.

4. The computer-implemented method of claim 1, wherein configuring each Operator Controller to execute as the separate process comprises configuring each Operator Controller to execute with a different specified environment parameter.

5. The computer-implemented method of claim 4, wherein the different specified environment parameter for each Operator Controller specifies a different corresponding custom resource definition (CRD) for a corresponding custom resource in at least one customer resource.

6. The computer-implemented method of claim 1, further comprising:
configuring the Operator Deployment to implement a health check method comprising a health check script to check and report a status of each Operator Controller in the plurality of Operator Controllers;
executing the health check script when running the Operator of the Operator Container; and
monitoring the execution of each Operator Controller based on the executing of the health check script.

7. The computer-implemented method of claim 6, wherein the health check script executes to generate a user interface that outputs a display of the status of the plurality of Operator Controllers with respect to at least one of a readiness status or a liveness status of the plurality of Operator Controllers.

8. The computer-implemented method of claim 7, wherein the liveness status indicates whether or not any of the plurality of Operator Controllers is not running, and wherein the readiness status indicates whether or not the plurality of Operator Controllers has a NotReady status indicating that one or more of the plurality of Operator Controllers is not running correctly.

9. The computer-implemented method of claim 8, wherein, in response to the readiness status indicating the NotReady status, executing a graceful shutdown operation in which a delay time is configured to a value that permits each Operator controller to reach an end or wait state.

10. The computer-implemented method of claim 1, wherein each of the plurality of Operator Controllers executes in parallel with each other Operator Controller in the plurality of Operator Controllers.

11. A computer program product comprising a computer readable storage medium having a computer readable program stored therein, wherein the computer readable program, when executed on a computing device, causes the computing device to implement a computer container management platform in which Operators and Operator Controllers are used to manage at least one custom resource associated with a containerized application, and to:
receive an Operator Deployment comprising an Operator Container having an Operator with a plurality of Operator Controllers;
configure, by a process control manager (PCM) process, each Operator Controller to execute as a separate process from each of remaining Operator Controllers of the plurality of Operator Controllers;
run the Operator of the Operator Container at least by executing the plurality of Operator Controllers of the Operator in separate Operator runtimes based on the configuring of the plurality of Operator Controllers;
monitor execution of each Operator Controller to determine a failure state associated with each Operator Controller;
determine that the failure state of a first Operator Controller satisfies a failure threshold based on the monitoring of the execution; and
initiate a restart of the first Operator Controller and maintain execution of one or more other Operator Controllers in parallel to the restart of the first Operator Controller, wherein the initiation of the restart is based on the determination that the failure state of the first Operator Controller satisfies the failure threshold.

12. The computer program product of claim 11, wherein the Operator is configured to access a configuration parameter that specifies for each Operator Controller in the plurality of Operator Controllers, a corresponding customer resource definition (CRD) that is associated with the Operator Controller.

13. The computer program product of claim 11, wherein configuring each Operator Controller to execute as the separate process comprises configuring each Operator Controller to execute on a different port.

14. The computer program product of claim 11, wherein configuring each Operator Controller to execute as the separate process comprises configuring each Operator Controller to execute with a different specified environment parameter.

15. The computer program product of claim 14, wherein the different specified environment parameter for each Operator Controller specifies a different corresponding custom resource definition (CRD) for a corresponding custom resource in the at least one customer resource.

16. The computer program product of claim 11, further comprising:
configuring the Operator Deployment to implement a health check method comprising a health check script to check and report a status of each Operator Controller in the plurality of Operator Controllers;
executing the health check script when running the Operator of the Operator Container; and
monitoring the execution of each Operator Controller based on the executing of the health check script.

17. The computer program product of claim 16, wherein the health check script executes to generate a user interface that outputs a display of the status of the plurality of Operator Controllers with respect to at least one of a readiness status or a liveness status of the plurality of Operator Controllers.

18. The computer program product of claim 17, wherein the liveness status indicates whether or not any of the plurality of Operator Controllers is not running, and wherein the readiness status indicates whether or not the plurality of Operator Controllers has a NotReady status indicating that one or more of the plurality of Operator Controllers is not running correctly.

19. The computer program product of claim 18, wherein, in response to the readiness status indicating the NotReady status, executing a graceful shutdown operation in which a delay time is configured to a value that permits each Operator controller to reach an end or wait state.

20. An apparatus comprising:
at least one processor; and
at least one memory coupled to the at least one processor, wherein the at least one memory comprises instructions which, when executed by the at least one processor, cause the at least one processor to implement a computer container management platform in which Operators and Operator Controllers are used to manage at least one custom resource associated with a containerized application, and to:
receive an Operator Deployment comprising an Operator Container having an Operator with a plurality of Operator Controllers;
configure, by a process control manager (PCM) process, each Operator Controller to execute as a separate process from each of remaining Operator Controllers of the plurality of Operator Controllers;
run the Operator of the Operator Container at least by executing the plurality of Operator Controllers of the Operator in separate Operator runtimes based on the configuring of the plurality of Operator Controllers;
monitor execution of each Operator Controller to determine a failure state associated with each Operator Controller;
determine that the failure state of a first Operator Controller satisfies a failure threshold based on the monitoring of the execution; and
initiate a restart of the first Operator Controller and maintain execution of one or more other Operator Controllers in parallel to the restart of the first Operator Controller, wherein the initiation of the restart is based on the determination that the failure state of the first Operator Controller satisfies the failure threshold.
